(19) United States
(12) Patent Application Publication
(10) Pub. No.: US 2011/0246282 A1
(43) Pub. Date: Oct. 6, 2011

(54) Business Transaction Method and System

(76) Inventor: Kuan-Hsin Chen, Douliou City (TW)

(21) Appl. No.: 13/006,533

(22) Filed: Jan. 14, 2011

(30) Foreign Application Priority Data
Apr. 1, 2010 (TW) 099110108

(51) Int. Cl. G06Q 30/00

(52) U.S. Cl. 705/14.34

(57) ABSTRACT

A business transaction method enables customers to purchase products from vendors, and is implemented using a business transaction system that includes a membership module, an allocation module, and a rebate module. The business transaction method includes: a) configuring the membership module to enable the vendors to become alliance members and the customers to become club members, and to set a recruiter of each club member to be a first-degree upper-tier member of said each club member; b) when one of the club members makes a purchase of a transaction amount from one of the alliance members, configuring the allocation module to allocate a predetermined percentage of the transaction amount as a rebate; and c) configuring the rebate module to distribute a portion of the rebate to the club member who made the purchase and another portion of the rebate to the first-degree upper-tier member thereof.

### CROSS REFERENCE TO RELATED APPLICATION

This application claims priority of Taiwanese Application No. 099110108 filed on Apr. 1, 2010, the disclosure of which is hereby incorporated by reference.

### BACKGROUND OF THE INVENTION

1. Field of the Invention

The present invention relates to a business transaction method and system, and more particularly, to a business transaction method and system used to enable customers to purchase products from vendors.

2. Description of the Related Art

When a product is being sold, some sort of a sales promotion is often used to attract the interest of customers. However, there are limits to how much customers may be rewarded, particularly in consideration of ever-reducing profit margins for many products and the need to maintain market prices.

In one example of a sales promotion, after a customer purchases a relatively low-priced product that would yield a slight profit margin for the vendor, the customer receives a small gift, a minimal rebate, or points for accumulation to obtain a larger reward in the future. An advantage of such a sales promotion technique is that each customer obtains a reward. However, because of the low profit margin, the gift, rebate, points, etc. given to the customer is of little value. As a result, the ability of such a technique to promote sales is limited.

In another example, a vendor sets aside a portion of profit from each transaction to purchase a gift with a high value. Through a drawing, the gift is given to a customer who made a past purchase, and who entered the drawing and was a lucky winner. An advantage of this method is that the winning customer can obtain a prize having a substantial value. A drawback, however, is that the number of prizewinners is limited. Hence, this technique also has limited success in promoting sales.

Some vendors allow customers to make group purchases. This involves a group of customers making a bulk purchase with a reduced unit price for each item. An advantage of this method is that the customers are able to obtain a much lower price than if they were to purchase the items separately. However, this method also has several drawbacks for the customers. For example, typically only a single product is involved in a group purchase. Further, difficulties may be faced by the customers in getting enough people interested in making a bulk purchase. Another drawback is that after the purchase is made, the products often need to be delivered, and so the customers have a waiting period before receiving their purchased products.

Taiwanese Patent Publication No. 200300896 discloses an electronic business rebate system, in which rebates are given to members. However, since the rebates are allocated to all the members, the actual rebate obtained by each member is extremely small. Moreover, a technique is used in this conventional system in which the members who joined earlier than other members get a higher portion of the rebates.

### SUMMARY OF THE INVENTION

Therefore, the object of the present invention is to provide a business transaction method and system, in which rebates are given in an equitable manner to customers who make purchases from vendors and their recruiters.

According to one aspect, the business transaction method of this invention enables customers to purchase products from vendors, and is implemented using a business transaction system that includes a membership module, an allocation module, and a rebate module. The business transaction method comprises:

a) configuring the membership module to enable the vendors to become alliance members and the customers to become club members, and to set a recruiter of each club member to be a first-degree upper-tier member of said each club member;

b) when one of the club members makes a purchase of a transaction amount from one of the alliance members, configuring the allocation module to allocate a predetermined percentage of the transaction amount as a rebate; and

c) configuring the rebate module to distribute a portion of the rebate to the club member who made the purchase and another portion of the rebate to the first-degree upper-tier member of the club member who made the purchase.

According to another aspect, the business transaction system of this invention enables customers to purchase products from vendors, and comprises:

a membership module which enables the vendors to become alliance members and the customers to become club members, and which sets a recruiter of each club member to be a first-degree upper-tier member of said each club member;

an allocation module which, when one of the club members makes a purchase of a transaction amount from one of the alliance members, allocates a predetermined percentage of the transaction amount as a rebate; and

a rebate module which distributes a portion of the rebate to the club member who made the purchase and another portion of the rebate to the first-degree upper-tier member of the club member who made the purchase.

### BRIEF DESCRIPTION OF THE DRAWINGS

Other features and advantages of the present invention will become apparent in the following detailed description of the preferred embodiments with reference to the accompanying drawings, of which:

FIG. 1 is a schematic diagram, illustrating a transaction platform established by the present invention;

FIG. 2 is a schematic block diagram of the preferred embodiment of a business transaction system according to the present invention;

FIG. 3 is a schematic diagram for illustrating relationships among a customer, a vendor, a financial institution, and a manager, and further illustrates an example of the process when the customer makes a purchase from the vendor;

FIG. 4 is a flowchart of the preferred embodiment of a business transaction method according to the present invention;

FIG. 5 is a schematic diagram used to describe a rebate mechanism according to the present invention; and

FIG. 6 is a schematic diagram used to describe an exemplary rebate mechanism according to the present invention involving a club member and his or her first- and second-degree upper tier members.

### DETAILED DESCRIPTION OF THE PREFERRED EMBODIMENTS

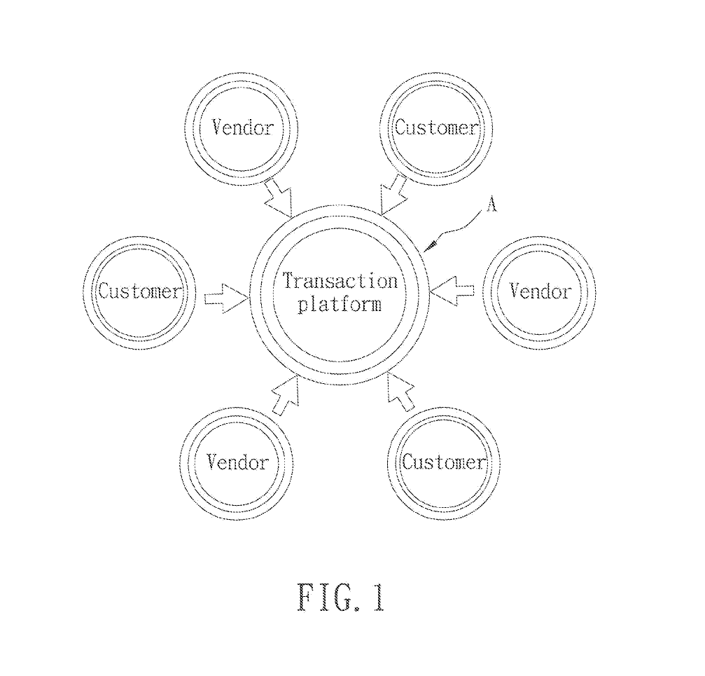

Referring to FIGS. 1, 2, and 3, the preferred embodiment of a business transaction system according to the present invention is a computer that delivers content over the Internet to operate as a transaction platform A for allowing customers to purchase products from vendors. In the preferred embodiment, the business transaction system comprises a membership module 1, a verification module 2, an allocation module 3, and a rebate module 4.

The membership module 1 enables the vendors to become alliance members and the customers to become club members. As an example, the customers may become club members by accessing the transaction platform A and providing personal information as required. It is to be noted that “club member” may be used interchangeably herein with “customer” and “alliance member” with “vendor.”

The membership module 1 also issues each club member a certificate C. The certificate C may be a co-branded card, a prepaid card, a membership card, a credit card, a debit card, an account number, a password, or any combination thereof. The membership module 1 also sets a recruiter of each club member to be a first-degree upper-tier member of said each club member.

The verification module 2 performs a verification check of the certificate C of one of the club members when said one of the club members is making a purchase. The verification module 2 also records the personal information of each club member. In some embodiments, the verification module 2 accesses the personal information of each club member which is stored in another location.

The allocation module 3 allocates a predetermined percentage of a transaction amount as a rebate when one of the club members makes a purchase of a transaction amount from one of the alliance members.

The rebate module 4 distributes a portion of the rebate to the club member who made a purchase and another portion of the rebate to the first-degree upper-tier member of the club member who made the purchase. In some embodiments, the rebate module 4 is linked to at least one financial institution 5, and the rebate is directly deposited into the accounts of the club member who made the purchase and the first-degree upper-tier member of this club member who made the purchased. In some embodiments, the allocation module 3 is also linked to the financial institution 5. In such embodiments where the allocation module 3 is also linked to the financial institution 5, the allocation module 3 may allocate predetermined percentages of transaction amounts as rebates by depositing the rebates into a specific account(s) set up for this purpose at the financial institution 5.

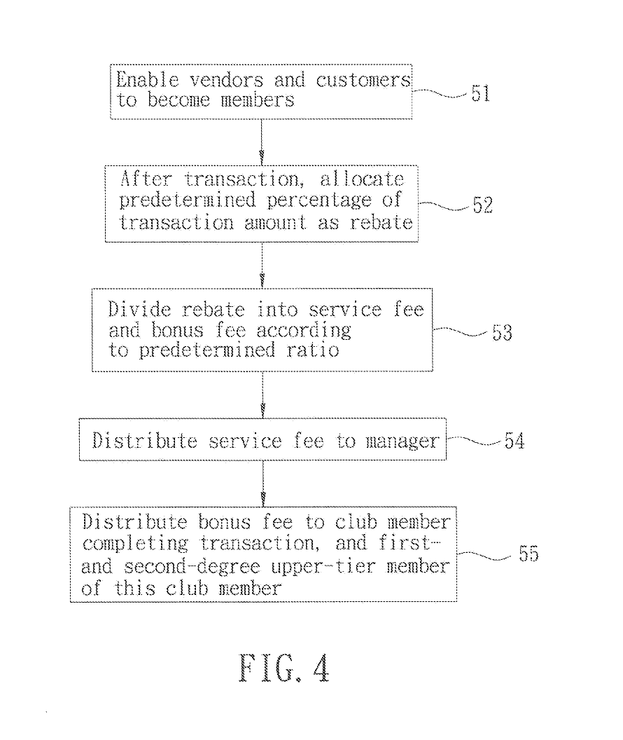

Referring to FIGS. 1 to 4, the preferred embodiment of a business transaction method of the present invention will now be described. The business transaction method enables customers to purchase products from vendors, and is implemented using the business transaction system of the present invention described above.

In step 51, the membership module 1 is configured to enable the vendors to become alliance members and the customers to become club members, to issue each of the club members a certificate C, and to set a recruiter of each club member to be a first-degree upper-tier member of said each club member.

In some embodiments, the membership module 1 is configured to set a recruiter of the first-degree upper-tier member of said each club member as a second-degree upper-tier member of said each club member. For example, when a new customer registers and becomes a club member (P1), the recruiter of the club member (P1) becomes the first-degree upper-tier member (P2) of the club member (P1), and the recruiter of the first-degree upper-tier member (P2) becomes the second-degree upper-tier member (P3) of the club member (P1).

In some embodiments, when one of the club members makes a purchase of a transaction amount from one of the alliance members, the verification module 2 is configured to perform a verification check of the certificate C of said one of the club members. If the verification check is successful, the flow continues with the following step. However, if the verification check is unsuccessful, the flow returns to step 51.

In step 52, after a transaction of a transaction amount is conducted, the allocation module 3 allocates a predetermined percentage of the transaction amount as a rebate.

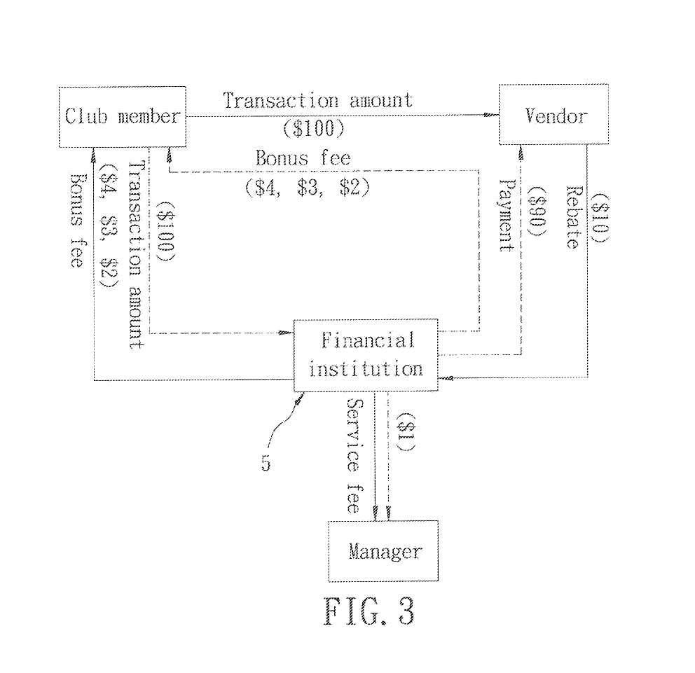

As an example, with reference to the solid lines in FIG. 3, when a club member purchases, for example, a watch with a purchase price of 100 dollars from an alliance member, the allocation module 3 allocates 10 dollars as the rebate by accessing the account of the alliance member through the financial institution 5. With reference to the dotted lines in FIG. 3, if the club member pays using a co-branded card, a prepaid card, a credit card, or a debit card, then after completion of the transaction, again assuming 10% to be the predetermined percentage of the transaction amount for use as the rebate, the allocation module 3 allocates 10 dollars as the rebate through the financial institution 5, and pays the alliance member 90 dollars for the product, also through the financial institution 5.

In some embodiments, a discount may be given to the club member, in which case the club member pays the alliance member a reduced amount when directly making the purchase from the alliance member, or the allocation module 3 allocates a reduced amount to the alliance member when payment is made through a co-branded card, a prepaid card, a credit card, or a debit card.

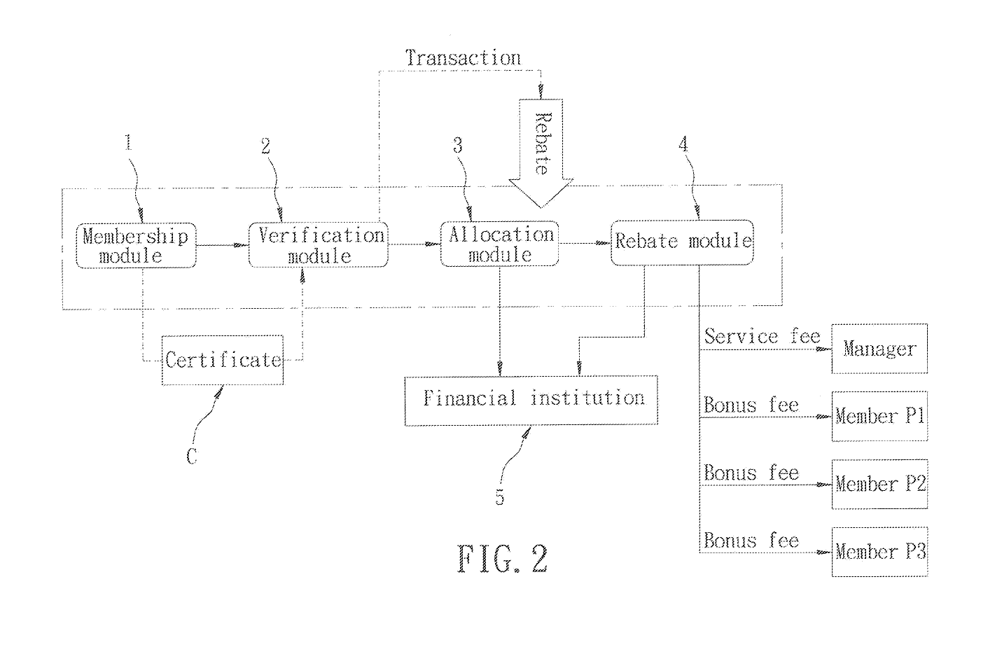

Next, in step 53, the rebate module 4 divides the rebate into a service fee and a bonus fee. For example, with reference to FIGS. 2 and 3, the rebate module 4 may divide the rebate into one portion of service fee and three different portions of bonus fee according to the ratio of 1:4:3:2, and then distribute the service fee to the account of the manager of the business transaction system in step 54 and the three different portions of the bonus fee to the accounts of club members in step 55.

For instance, assuming a rebate of 10 dollars, the rebate module 4 may divide this into four different portions according to the aforementioned ratio of 1:4:3:2, that is, a service fee of 1 dollar, and bonus fees consisting of the three amounts of 4 dollars, 3 dollars, and 2 dollars. Hence, in this case, the manager of the business transaction system is paid the service fee of 1 dollar in step 54. Moreover, in this example, the rebate module 4 distributes the bonus fees to the accounts of the club member completing the transaction, the first-degree upper-tier member of this club member, and the second-degree upper-tier member of this club member. That is, the club member (P1) completing the transaction is granted a bonus fee of 4 dollars, the first-degree upper-tier member (P2) is granted a bonus fee of 3 dollars, and the second-degree upper-tier member (P3) is granted a bonus fee of 2 dollars.

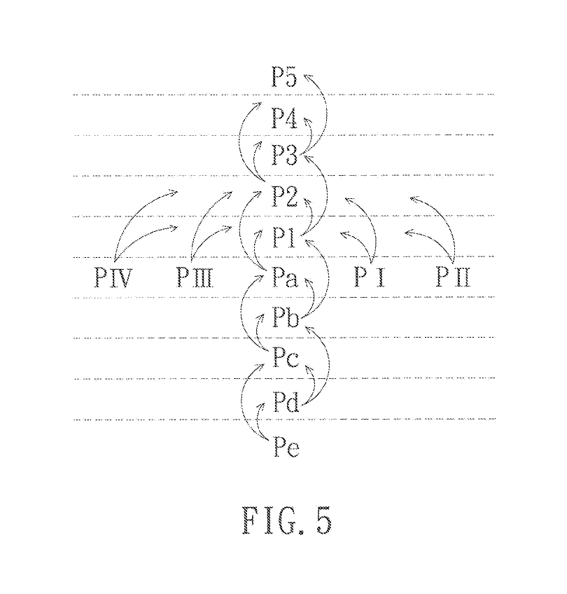

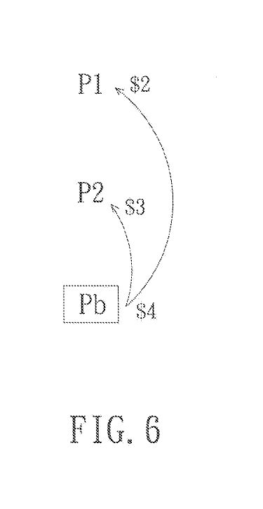

Referring to FIGS. 5 and 6, even if a club member him or herself does not make a purchase, he or she can still obtain a rebate from a lower-tier member who has made a purchase. For example, when the club member (P1) completes a business transaction, the club member (P1) is granted a bonus fee of 4 dollars, the first-degree upper-tier member (P2) is granted a bonus fee of 3 dollars, and the second-degree upper-tier member (P3) is granted a bonus fee of 2 dollars, as described above. Moreover, the club member (P1) not only can be granted a bonus fee from a business transaction of a club member (Pa), but also may be granted multiple bonus fees from business transactions conducted by other lower-tier members (PI), (PII), (PII), (PIV), etc. Hence, the more lower-tier members the club member (P1) has, the greater the potential for the club member (P1) to be granted more bonus fees.

In some embodiments, if the club member (P1) does not have any upper-tier members, the rebate module 4 will distribute the other two bonus fees into a public fund, which may be used, for example, by the manager of the business transaction system to provide as a rebate to customers through a drawing mechanism or to use as promotion expenditures for the business transaction system.

The business transaction method and system according the present invention have advantages as outlined below.

The advantages for the customer are first discussed.

1) The customer does not need to change his or her purchasing habits, and is able to choose a product to his or her liking from many alliance vendors based on a comparison of price, brand, functionality, etc. Hence, the customer is not limited with respect to vendor and product.

2) After each transaction, the customer is immediately granted a bonus fee. Therefore, the customer is able to obtain a rebate without having to accumulate bonus points or pay any fees. Moreover, the larger the number of lower-tier members, the greater the accumulated bonus fees for each club member. Stated differently, even if the customer does not buy a product, he or she can still obtain rebates through purchases made by lower-tier members.

3) The business transaction system of this invention can be connected directly to the financial institution 5 for real-time account transfers, allowing the bonus fees to be deposited into individual accounts at the financial institution 5. This enhances security and convenience for the customer.

4) Compared with Taiwan Patent Publication No. 200300896, this invention ensures that the customer who actually performs a transaction is the greatest beneficiary, as opposed to others benefiting more when the customer makes a purchase.

The advantages for the vendor are now discussed.

1) Since the rebate distributed from a transaction is roughly equivalent to a discount amount used for promotion purposes, the profits for the vendor are not negatively affected by the mechanism employed in the present invention. On the contrary, as a result of the increase in business volume resulting from the use of the present invention, the profit is also increased accordingly.

2) Since products are sold via the Internet in the preferred embodiment of this invention, fees charged by middlemen are avoided. Therefore, profits for the vendor are increased. Moreover, as a result of the use of the Internet in the present invention, it is possible for the vendor to easily expand to different customer groups and markets.

The advantages for the manager of the business transaction method and system of the present invention are now described.

1) Since the bonus fees granted to a club member may be quickly accumulated and eventually exceed the price of one or more products, sales are promoted through the use of the present invention. Moreover, the number of customers may be increased rapidly to form a large customer base, and through use of this large customer base, the manager can gain leverage when negotiating with vendors. Additionally, the cost of obtaining products may be reduced and more discounts can be obtained, further resulting in more benefits for club members. As a result, the scale of business for the mangers will continuously increase.

2) Since customers can obtain bonus fees from the transactions made by his or her lower-tier members, the customers will try their best to recruit others to become their lower-tier members. Hence, customers perform the advertising function in the present invention, thereby significantly reducing advertising expenditures for the manager.

3) Since each customer becoming a lower-tier member through recommendation by another customer benefits the most from any transaction he or she makes with the use of the present invention, no negative feeling are generated between club members. This also helps in customers actively promoting use of the present invention for the manager.

While the present invention has been described in connection with what are considered the most practical and preferred embodiments, it is understood that this invention is not limited to the disclosed embodiments but is intended to cover various arrangements included within the spirit and scope of the broadest interpretation so as to encompass all such modifications and equivalent arrangements.

What is claimed is:

1. A business transaction method for enabling customers to purchase products from vendors, said business transaction method being implemented using a business transaction system that includes a membership module, an allocation module, and a rebate module, said business transaction method comprising:
a) configuring the membership module to enable the vendors to become alliance members and the customers to become club members, and to set a recruiter of each club member to be a first-degree upper-tier member of said each club member;
b) when one of the club members makes a purchase of a transaction amount from one of the alliance members, configuring the allocation module to allocate a predetermined percentage of the transaction amount as a rebate; and
c) configuring the rebate module to distribute a portion of the rebate to the club member who made the purchase and another portion of the rebate to the first-degree upper-tier member of the club member who made the purchase.

2. The business transaction method of claim 1, wherein in step c), the rebate module is configured to distribute a further portion of the rebate to a manager of the business transaction system.

3. The business transaction method of claim 1, wherein:
in step a), the membership module is configured to set a recruiter of the first-degree upper-tier member of said each club member as a second-degree upper-tier member of said each club member; and
in step c), the rebate module is configured to distribute a further portion of the rebate to the second-degree upper-tier member of said each club member.

4. The business transaction method of claim 1, wherein in step a), the membership module is configured to issue each of the club members a certificate.

5. The business transaction method of claim 4, wherein the certificate is one of a co-branded card, a prepaid card, a membership card, a credit card, a debit card, an account number, and a password.

6. The business transaction method of claim 4, the business transaction system further including a verification module, wherein in step b), the verification module is configured to perform a verification check of the certificate of said one of the club members when said one of the club members is making the purchase.

7. The business transaction method of claim 1, wherein the business transaction system is a computer that delivers content over the Internet to operate as a transaction platform for allowing the club members to purchase products from the alliance members.

8. The business transaction method of claim 1, the rebate module being linked to at least one financial institution, wherein in step c), the rebate module is configured to distribute said portion of the rebate to the club member who made the purchase and said another portion of the rebate to the first-degree upper-tier member of the club member who made the purchase via the financial institution.

9. A business transaction system for enabling customers to purchase products from vendors, said business transaction system comprising:
a membership module which enables the vendors to become alliance members and the customers to become club members, and which sets a recruiter of each club member to be a first-degree upper-tier member of said each club member;
an allocation module which, when one of the club members makes a purchase of a transaction amount from one of the alliance members, allocates a predetermined percentage of the transaction amount as a rebate; and
a rebate module which distributes a portion of the rebate to the club member who made the purchase and another portion of the rebate to the first-degree upper-tier member of the club member who made the purchase.

10. The business transaction system of claim 9, wherein said rebate module distributes a further portion of the rebate to a manager of the business transaction system.

11. The business transaction system of claim 9, wherein:
said membership module sets a recruiter of the first-degree upper-tier member of said each club member as a second-degree upper-tier member of said each club member; and
said rebate module distributes a further portion of the rebate to the second-degree upper-tier member of said each club member.

12. The business transaction system of claim 9, wherein said membership module issues each of the club members a certificate.

13. The business transaction system of claim 12, wherein the certificate is one of a co-branded card, a prepaid card, a membership card, a credit card, a debit card, an account number, and a password.

14. The business transaction system of claim 12, further comprising a verification module which performs a verification check of the certificate of said one of the club members when said one of the club members is making the purchase.

15. The business transaction system of claim 9, wherein said business transaction system is a computer that delivers content over the Internet to operate as a transaction platform for allowing the club members to purchase products from the alliance members.

16. The business transaction system of claim 9, wherein said rebate module is linked to at least one financial institution, said rebate module distributing said portion of the rebate to the club member who made the purchase and said another portion of the rebate to the first-degree upper-tier member of the club member who made the purchase via the financial institution.
